(19) United States
(12) Patent Application Publication
(10) Pub. No.: US 2003/0061994 A1
(43) Pub. Date: Apr. 3, 2003

(54) Device and method for separating milk from a dairy animal

(76) Inventors: Helena Geralda Maria Vijverberg, Maassluis (NL); Elena Espada Aventin, Delft (NL)

Correspondence Address: HOWREY SIMON ARNOLD & WHITE, CITYPOINT, ONE ROPEMAKER STREET, LONDON, EC2Y 9HS, GB

(21) Appl. No.: 10/255,173

(22) Filed: Sep. 26, 2002

(30) Foreign Application Priority Data
Sep. 28, 2001 (NL) 1019060

(51) Int. Cl. A01J 3/00; A01J 5/00

(52) U.S. Cl. 119/14.15

(57) ABSTRACT

A device for separating milk obtained from a dairy animal. The device is provided with a processing device and with a measuring device for measuring a value of a variable in relation to the dairy animal and for issuing a signal indicative of the measured value to the processing device. The processing device comprises a memory suitable for containing a reference value for the variable in relation to the dairy animal. The processing device comprises a comparing device for comparing the measured value of the variable with the reference values and for issuing a comparison signal, the device separating milk in dependence on the comparison signal. The device is provided with a means for determining the period between two successive milking runs of the dairy animal, and the memory contains various reference values for the variable, the reference values depending on the measured period.

### CROSS REFERENCE TO RELATED APPLICATIONS

This application claims priority from the Netherlands application number 1019060 filed on Sep. 28, 2001, the contents of which are hereby incorporated by reference in their entirety.

### BACKGROUND OF THE INVENTION

1. Field of the Invention

The present invention relates to devices and methods for separating milk from a dairy animal. In this context, separating is used to refer to accepting or rejecting, or sorting milk according to particular criteria.

2. Description of the Related Art

Such a device is known from EP-A-1000535. The device known therefrom is provided with a measuring device in the form of a color measuring system provided with one or more sensors comprising one or more sources irradiating the milk successively or simultaneously with radiation of one or more different wavelengths and/or different intensities, while, during at least a part of the time when the sources are in their switched-on position, one or more receivers establish the radiation intensity during a time interval. When the obtained measurement data indicate that the color of the measured milk deviates from normal values, the relevant milk is separated. However, it has appeared that the known device sometimes draws a wrong conclusion on the basis of the color measurements, so that e.g. suitable milk is not used for being processed further, but is discharged.

### BRIEF SUMMARY OF THE INVENTION

It is therefore desirable to provide an improved device for separating milk from a dairy animal by means of which the decision whether or not milk obtained is suitable for being processed further can be taken in a more accurate manner. According to the present invention, for that purpose there is disclosed a device for separating milk obtained from a dairy animal during a milking run, the device comprising a measuring device for measuring a value of a variable in relation to the dairy animal and for issuing a signal indicative of the measured value and a processing device for receiving the signal indicative of the measured value the processing device further comprising a memory for storing a plurality of reference values for the variable corresponding to different periods between milking runs of the dairy animal and a comparing device for comparing the measured value of the variable with a selected reference value and for issuing a comparison signal. The selected reference value is selected on the basis of a period since a preceding milking run of the dairy animal and the device separates milk in dependence on the comparison signal.

The invention is based on the insight that the measured value of the variable depends on the measured period, also called interval, even when the condition of the dairy animal remains unchanged. By including in the memory, according to the invention, various reference values for the variable, the reference values depending on the measured period, in other words being a function of the period i.e. the interval between two successive milking runs, it is possible to make a more accurate comparison of the measured values, so that a correct decision can be taken whether or not the milk is suitable for being processed further. Moreover, after comparison of the measured values with the reference values, it is possible to draw more correct conclusions in relation to the condition, respectively the health of the dairy animal. Determination of the period between two successive milking runs may take place by means of a clock measuring the period of time, or by means of a counter counting the number of cows having been milked between the two successive milking runs or by any other appropriate means.

It is noticed that from WO 99/31965 it is known per se to vary a threshold value in dependence on the interval for determining the extent to which the udder of a dairy animal has been emptied.

The measuring device of the present invention preferably comprises a color sensor measuring system for measuring the intensity of at least one wavelength band, in particular in the visible wavelength range, of the milk obtained from the dairy animal, the variable being the intensity of the wavelength band. With the aid of the color sensor measuring system especially the intensity of the separate colors in the milk obtained from the separate udder quarters may be established. Therefore, in this embodiment the variable is constituted by the color of the milk obtained.

In an embodiment of a device according to the invention the measuring device is constituted by a flow sensor for measuring the flow of the milk obtained during the milking run. The flow sensor preferably measures the flow of the milk obtained from the separate udder quarters.

In a further embodiment of a device according to the invention the measuring device comprises a conductivity meter known per se for measuring the conductivity of the milk obtained during the milking run. The conductivity meter preferably measures the conductivity of the milk obtained from the separate udder quarters.

In a still further embodiment of a device according to the invention the measuring device comprises a thermometer for measuring the temperature of the milk obtained during the milking run. The thermometer preferably measures the temperature of the milk obtained from the separate udder quarters.

In another further embodiment of a device according to the invention the measuring device comprises a component meter for measuring the quantity of a component of the milk obtained during the milking run, such as fat, protein, urea, bacteria, sugars, free fatty acids, germs, etc. The component meter preferably measures the components of the milk obtained from the separate udder quarters.

In again a further embodiment of a device according to the invention the measuring device comprises a quantity meter for measuring the quantity of the milk obtained during the milking run. The quantity meter preferably measures the quantity of the milk obtained from the separate udder quarters.

In a still further embodiment of a device according to the invention the measuring device comprises an activity meter for measuring the activity of the dairy animal during the milking run.

By adapting the measuring device for measuring the value of the milk variable during the entire course of the milking run for obtaining a measurement pattern of the milk variable, and adapting the memory for storing this measurement pattern, it is possible to take a still more accurate decision whether or not the obtained milk should be processed further. Comparing measurement patterns with reference patterns appears to result in more correct decisions than exclusively comparing one single measured value.

The processing device is in particular provided with an averaging device for determining the average of a measurement pattern of a milk variable, it being advantageous that the memory is suitable for storing the average measurement pattern. Such an average measurement pattern is extremely suitable for determining deviations from this average pattern, which may be an indication that the condition of the dairy animal is different from normal or that the milk produced by the dairy animal is different from normal. Such an average measurement pattern appears to provide per animal a more accurate indication of the deviation than a predetermined reference value, especially when the average is a so-called progressive average, i.e. an average over e.g. the last ten milking runs (another number is possible as well).

In an embodiment of a device according to the invention the memory is suitable for storing a reference pattern.

Although for all the animals the same thresholds may be used, it is advantageous that the memory of the processing device contains an upper threshold pattern and/or a lower threshold pattern for a relevant measurement pattern of a milk variable for each animal.

In a further embodiment of a device according to the invention the processing device is provided with a comparing device for comparing a momentary measurement pattern of a milk variable with the stored measurement pattern of the milk variable, and for issuing a comparison signal indicative of the comparison result. It is thus possible, by providing the device with a milk line system comprising a number of lines and with at least one device controlled by the comparison signal for guiding milk flowing through the milk line system to a relevant line, to discharge automatically unsuitable milk or to convey suitable milk for being processed further.

For the purpose of enabling visual checking it is advantageous that the device comprises a displaying device for displaying the comparison signal. The device may also comprise a device for generating a warning, said warning device being controlled by the comparison signal, it is possible, in certain situations, to give a warning to the manager of the device, e.g. in the form of a sound signal.

The invention further relates to a method for separating milk obtained from a dairy animal during a milking run, the method comprising: measuring a value of a variable in relation to the dairy animal; storing a plurality of reference values for the variable corresponding to different periods between milking of the dairy animal; selecting one of the reference values on the basis of a period since a preceding milking run of the dairy animal; comparing the measured value of the variable with the selected reference value; and separating the milk based on the result of the comparison.

### BRIEF DESCRIPTION OF THE DRAWINGS

The invention will be explained hereinafter in further detail with reference to an embodiment shown in the drawing, in which:

FIG. 1 is a schematic view of a device for milking a cow, provided with a color sensor measuring system, and

FIG. 2 is a schematic view of a milking box with a milking robot provided with means for measuring a variable in relation to the cow.

### DESCRIPTION OF ILLUSTRATIVE EMBODIMENTS

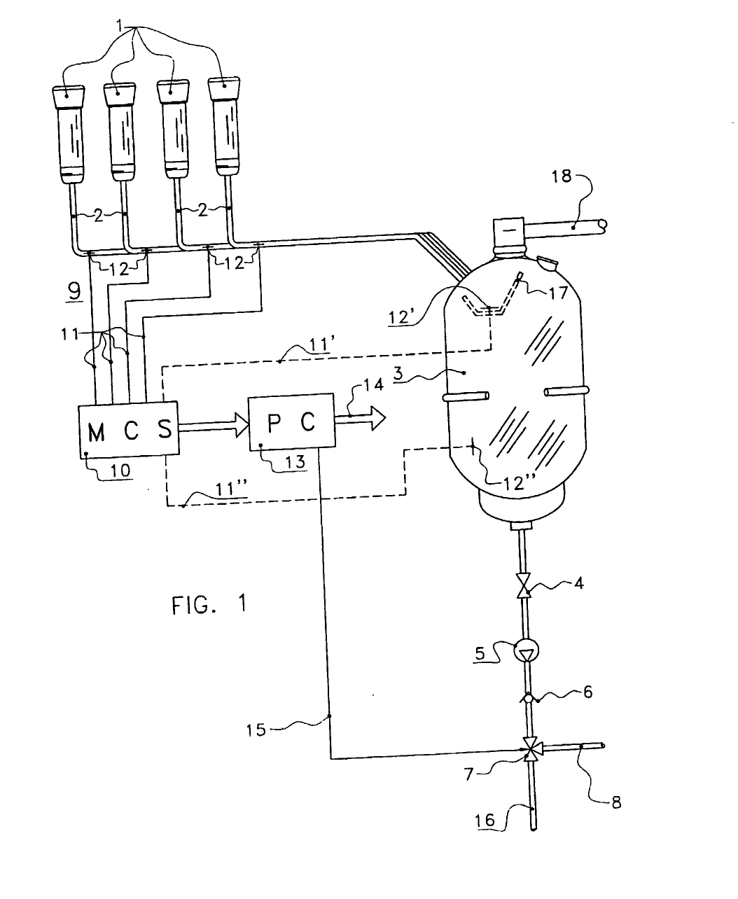

FIG. 1 illustrates a device for milking a cow according to the present invention. Another application Serial No. ______ based on Netherlands application No. 1019059 and filed concurrently herewith relates to similar subject matter, the contents of which are hereby incorporated by reference in their entirety.

FIG. 1 shows four teat cups 1 to be connected to the teats of an animal to be milked, the milk discharge lines 2 of said teat cups 1 opening into a milk glass 3. To the milk glass 3 there is further connected a vacuum line 18 for the purpose of applying a vacuum in the milk glass 3 itself, in the milk discharge lines 2 and in the teat cups 1, said vacuum being required for keeping the teat cups connected to the teats of the animal, for enabling milking and for separating milk and air present therein from each other in the milk glass 3. From the milk glass 3 the milk obtained is discharged via a valve 4, a pump 5, a non-return valve 6 and a three-way valve 7 through a line 8 to a not further shown milk tank.

FIG. 1 further shows a color sensor measuring system 9, said measuring system comprising a color intensity processing unit (MCS) 10, to which four sensors 12 are connected via glass fibre cables 11. Said sensors 12 are disposed in the milk lines 2 for establishing the intensity of a number of defined colors in the milk and for supplying signals representing these intensities to the processing unit 10. As a color sensor measuring system may be used the Modular Color Sensor system CS1 of Stracon Messsysteme GmbH, Im Camisch 10, Kahla. The sensors used in this system are sensitive to frequencies in frequency bands for red (R), green (G) and blue (B). Therefore there are issued three signals per measurement, which may be considered as intensity values for these three colors.

Although until now the opinion prevailed that for milk of a constant composition these three intensity values have a fixed mutual relation, said relation depending amongst other things on the impurities and components in the milk, it has appeared that the relation between the three intensity values depends on the interval, in other words depends on the period between two successive milking runs. Said period may be a period of time measured by a clock or a number of cows milked between two successive milking runs, said number being determined by a counter.

The color intensity processing unit (MCS) 10 comprises a computer (PC) 13 (shown in the figure separately from the color intensity processing unit (MCS) for the sake of clearness), in which for each animal to be milked there is a file in which all data required for milking a relevant animal are stored.

At each milking run also the obtained three intensity values of the relevant colors in the milk are stored. These intensity values stored at each milking run form the so-called historical intensity values. The progressive average may be determined from the historical intensity vales obtained for a certain animal during a defined number of the last milking runs carried out. Upon averaging milking runs with equal intervals should be used. The intensity values obtained at a next milking run with an equal interval may be compared with this progressive average, i.e. the last obtained intensity value of each of the three colors may be compared with the corresponding intensity value belonging to that interval, recorded in the computer as a progressive average. In other words, the intensity values are compared both mutually and with corresponding intensity values recorded during one or more previous milking runs with an equal interval. This comparison process takes place in the computer 13 which also functions as a comparing device. Subsequently the results of this comparison process may be displayed on a displaying device in such a manner that the presence of certain substances, such as impurities, in the milk can be read directly there from. These results may be supplied via the line 14 to a screen or to a printer.

Instead of determining the progressive average of the intensity values for each of the colors, it is also possible to determine in another manner for each color a calibration value, such as in particular a reference pattern, respectively a lower threshold pattern or an upper threshold pattern. It is possible to apply calibration values which could hold for the milk obtained from all the animals or from a group of animals. In that case it will not be necessary to dispose a sensor 12 in each of the milk discharge lines 2, but an overflow reservoir 17 may be disposed in the milk glass 3, in which overflow reservoir there is provided such a sensor 12′ which is connected to the processing unit 10 via a glass fibre cable shown by a “dashed” line 11′. As a further alternative a sensor 12″ may be disposed in the lower part of the milk glass 3. Also in the latter case said sensor has to be connected to the processing unit 10 via a glass fibre cable 11″.

However, in all situations it applies that, when inadmissible quantities of undesired substances appear to be present in the milk, the computer 13 issues a signal over the line 15 to the three-way valve 7, via which three-way valve 7 and the discharge line 16 connected thereto the milk containing these undesired substances may be discharged separately.

When for example blood has come into the milk, the intensity value issued by the sensor 12 for the color red, will be higher than when no blood is present in the milk. This intensity value will then be higher than the progressive average established on the basis of the historical intensity values or higher than the calibration value applied (of course in dependence on the comparison with values belonging to the same interval). Also when there are no impurities in the milk, alterations in the concentration of substances normally being present in the milk may still be established. When for example the fat content of the milk changes in the course of the lactation period, then the mutual relation of the three intensity values established during each milking run changes as well.

Because the composition of the milk is different for different animals, which is even visually perceptible from the color, the intensity values for the three colors will have a mutually different ratio for different animals. Therefore it is advantageous to determine the intensity values for each animal separately at each milking run and to compare them with calibration values or, in particular, with progressive averages established for this specific animal (and belonging to the same interval).

An example of the dependence of the measured color intensity on the interval, said dependence having been proved clearly by means of the above-mentioned color sensor measuring system, is given hereinafter. It has further appeared that this dependence is reproducible. For a particular cow it has appeared that the intensity of the blue frequency band rises in a particular manner when the period of time, the interval, increases or the number of cows having been milked increases. It has further appeared that the intensity of the green frequency band shows a certain, slight fall at an increasing interval. The intensity of the red frequency band showed a certain slight rise. For this cow the total sum of the intensities appeared to rise to a maximum value at an increasing interval and to fall via a particular pattern at a further increasing interval. The value of the intensity in the red frequency band reduced by the value of the blue frequency band appeared to show with this cow a falling pattern at an increasing interval, whereas the quotient of the intensity in the red frequency band and the intensity in the green frequency band rose to a maximum value at an increasing interval and remained constant at a further increase of the interval. It will be obvious that upon comparing the milk obtained from this cow, at each interval there has to be taken a different reference value or pattern to decide whether or not the milk obtained is suitable for being processed further.

It has further appeared that the color intensity may differ per quarter, so that it is advantageous to compare the data per animal, per quarter, per interval, in order to be able to decide whether or not milk obtained from a quarter should be processed further.

It has further appeared that the flow of the milk obtained during the milking run depends on the interval. Also here, to be able to take a correct decision whether or not the milk obtained should be processed further, the measured flow values have to be compared with the reference value for that interval. It is noticed that a flow sensor for measuring the flow of the milk obtained during the milking run is known per se. In particular the flow sensor measures the flow of the milk obtained from the separate udder quarters. For the above-mentioned cow it has appeared that the flow rises at an increasing interval.

It has further appeared that the conductivity of the milk obtained for the mentioned cow rises at an increasing interval. A conductivity meter for measuring the conductivity of the milk obtained during the milking run, in particular per quarter, may then be used to take a correct decision whether or not the milk obtained (possibly per quarter) should be processed further.

It has further appeared that the temperature of the milk obtained for the mentioned cow rises at an increasing interval. In that situation a thermometer may be used for measuring the temperature of the milk obtained during the milking run, in particular for measuring the temperature of the milk obtained from the separate udder quarters, in order to take a correct decision whether or not the milk obtained (possibly per quarter) should be processed further.

Moreover it has appeared that for the mentioned cow the fat content of the milk obtained falls according to a certain curve at an increasing interval. Also for other components there appears to be a dependence between the quantity and the interval. A component meter for measuring the quantity of a component of the milk obtained during the milking run, such as fat, protein, urea, bacteria, sugars, free fatty acids, germs, etc., in particular the components of the milk obtained from the separate udder quarters, may then be used for taking a correct decision whether or not the milk obtained (possibly per quarter) should be processed further.

Furthermore it has appeared that for the mentioned cow the milk yield increases at an increasing interval. A quantity meter for measuring the quantity of the milk obtained during the milking run, in particular for measuring the quantity of the milk obtained from the separate udder quarters, may then be used in order to take a correct decision whether or not the milk obtained (possibly per quarter) should be processed further.

Research has also revealed that the activity of the mentioned cow, e.g. determined by means of a step counter, depends on the interval. Moreover it appears that an increased activity may indicate an udder inflammation, as a result of which the cow experiences pain and tries to kick off the teat cups during connection of the teat cups. Udder inflammation affects, as known, the quality of the milk, so that the activity may be used to determine the quality of the milk. The activity may also be determined in another manner, e.g. by measuring the heartbeat of the cow.

The above-mentioned relations have not only been found with a particular cow, but all cows appear to produce milk of which the measurable variables depend on the interval. Moreover cows also appear to show an interval-dependent activity. It will be obvious that the exact nature of that dependence can be determined by measurement.

As already mentioned above for color intensity measurement, a measured measurement pattern (also called measured curve) of the variable appears to be especially adapted to decide during the milking run whether or not milk obtained should be processed further. This applies in particular to the pattern of color, conductivity and flow during a milking run, although the other above-mentioned variables also show a pattern during the milking run, which pattern may be used for obtaining a correct decision whether or not milk obtained is suitable for being processed further.

In this situation an averaging device may determine the average of a measurement pattern of a milk variable and use this average as a reference pattern. Besides, other reference patterns are possible as well (e.g. an upper threshold pattern and/or a lower threshold pattern).

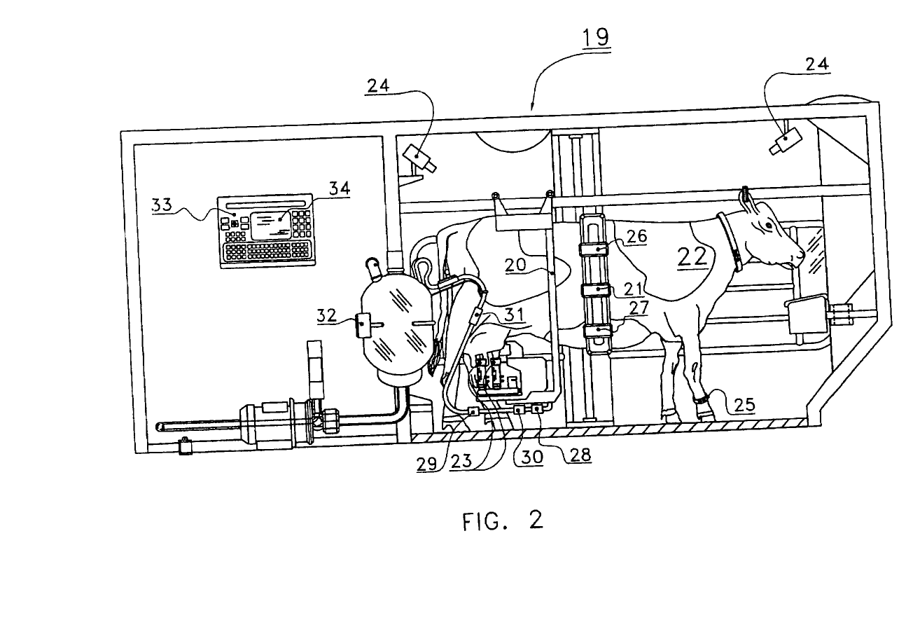

FIG. 2 shows schematically a milking box 19 with a milking robot 20, to which the invention applies in particular. In this figure various measuring devices for measuring variables in relation to the cow are shown schematically.

For example the heart beat may be measured by means of a band 21 including a heart beat meter around the leg or the abdomen of the cow 22. Alternatively or additionally a heart beat meter known per se may be provided on the cow 22 near a place where an artery is located, in this connection the udder or an ear of the cow may be taken into consideration. A suitable heart monitoring system is for example obtainable at Polar Electro Oy, Helsinki, Finland. Alternatively a heart beat meter may be included in at least one of the teat cups 23.

In the milking box 19 there may be disposed one or more cameras 24 for observing and measuring the activity of the cow 22. The video pictures are analysed by movement recognition equipment known per se for determining activity parameters such as stepping, kicking and the like. To that end the picture is compared per cow 22 with stored historical data regarding the cow 22. Also in this situation it applies, as mentioned above, that the historical data used for the comparison relate to the same interval.

There may further be provided a step counter 25, a muscle contraction meter 26 and/or a muscle vibration meter 27 for determining the activity of the cow 22.

A flow sensor 28 measures the flow of the milk obtained during a milking run. A conductivity meter 29 measures the conductivity of the milk obtained during a milking run. A thermometer 30 measures the temperature of the milk obtained during a milking run. A component meter 31 measures the components, e.g. protein and fat, in the milk obtained during the milking run, and the milk yield is measured by a quantity meter 32 or yield meter.

All these measurement data are transmitted to or read by a processing device 33 comprising a computer having a memory. Besides the measurement data the processing device 33 also stores the period of time elapsed since the same animal has been milked. Alternatively the number of cows having been milked since the last milking run of the relevant cow is stored. To that end the processing device 33 comprises a clock (not explicitly shown, but implicitly present in the computer) for determining the period of time between two successive milking runs of the dairy animal. Alternatively the processing device comprises a counter for counting the number of cows. In the memory of the computer of the processing device 33 reference values or reference patterns are stored per interval, per animal or per group of animals, possibly per quarter, and per milk variable, respectively these reference values or reference patterns are generated by the system itself. The processing device 33 comprises a comparing device (not shown) for comparing the measured value of the variable with the stored reference values. The comparing device issues a comparison signal, the value of which depends on the comparison result, and is thus indicative of the comparison result. This comparison signal may be displayed on a displaying device, such as a screen 34. As described above, the comparison signal may also be used for controlling a valve or the like, so that the milk obtained will be processed further or not. Should the comparison signal indicate a deviation, then it is also possible for the comparison signal to control a device for generating a warning (such as e.g. a loudspeaker) for issuing a signal (e.g. a sound) which is perceptible by a manager of the device.

It will be obvious that the measured values may be used separately, but that also combinations of measured values of different variables may be used for determining whether or not milk should be processed further (or for determining whether the condition of a dairy animal is within the standards). Thus a weight factor may be given to certain parameters for combining the measured values and/or comparison results obtained in a desired manner.

As described, FIG. 2 shows a side view of a milking box 19 with a cow 22 present therein. The milking box 19 is provided with a milking robot 20 with teat cups 23 which are automatically connected to the teats of the cow 22 by means of the milking robot 20. Near the front side of the milking box 19 there is further disposed a feeding trough to which concentrate may be supplied in metered quantities. Other elements of the milking box and the robot are not shown in the figure for the sake of clarity.

Many modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A device for separating milk obtained from a dairy animal during a milking run, the device comprising:
a measuring device for measuring a value of a variable in relation to the dairy animal and for issuing a signal indicative of the measured value; and
a processing device for receiving the signal indicative of the measured value and comprising:
a memory for storing a plurality of reference values for the variable corresponding to different periods between milking runs of the dairy animal; and
a comparing device for comparing the measured value of the variable with a selected reference value and for issuing a comparison signal,
wherein the selected reference value is selected on the basis of a period since a preceding milking run of the dairy animal and wherein the device separates milk in dependence on the comparison signal.

2. A device as claimed in claim 1, further comprising a clock for measuring the period of time between two successive milking runs to determine the period since a preceding milking run of the dairy animal.

3. A device as claimed in claim 1, further comprising a counter for counting the number of other dairy animals milked since the last milking run of the dairy animal to determine the period since a preceding milking run of the dairy animal.

4. A device as claimed in claim 1 wherein the measuring device comprises a color sensor measuring system for measuring intensity of at least one wavelength band of the milk obtained from the dairy animal, and wherein the variable is the intensity of the wavelength band.

5. A device as claimed in claim 4, wherein the color sensor measuring system provides information for determining the intensity of the separate colors in the milk obtained from separate udder quarters of the dairy animal.

6. A device as claimed in claim 1, wherein the measuring device comprises a flow sensor for measuring flow of the milk obtained during the milking run.

7. A device as claimed in claim 6, wherein the flow sensor measures the flow of the milk obtained from separate udder quarters of the dairy animal.

8. A device as claimed in claim 1, wherein the measuring device comprises a conductivity meter for measuring conductivity of the milk obtained during the milking run.

9. A device as claimed in claim 8, wherein the conductivity meter measures conductivity of the milk obtained from separate udder quarters of the dairy animal.

10. A device as claimed in claim 1, wherein the measuring device comprises a thermometer for measuring temperature of the milk obtained during the milking run.

11. A device as claimed in claim 10, wherein the thermometer measures temperature of the milk obtained from separate udder quarters of the dairy animal.

12. A device as claimed in claim 1, wherein the measuring device comprises a component meter for measuring a quantity of a component of the milk obtained during the milking run.

13. A device as claimed in claim 12, wherein the component meter measures the component of the milk obtained from separate udder quarters of the dairy animal.

14. A device as claimed in claim 1, wherein the measuring device comprises a quantity meter for measuring a quantity of the milk obtained during the milking run.

15. A device as claimed in claim 14, wherein the quantity meter measures the quantity of the milk obtained from separate udder quarters of the dairy animal.

16. A device as claimed in claim 1, wherein the measuring device comprises an activity meter for measuring activity of the dairy animal during the milking run.

17. A device as claimed in claim 1, wherein the measuring device measures the value of the variable during the entire course of the milking run for obtaining a measurement pattern of the variable, and the memory stores the measurement pattern.

18. A device as claimed in claim 17, wherein the processing device further comprises an averaging device for determining an average of the measurement pattern of the variable.

19. A device as claimed in claim 18, wherein the memory stores the average of the measurement pattern.

20. A device as claimed in claim 17 wherein the memory stores a reference pattern.

21. A device as claimed in claim 20, wherein the memory stores an upper threshold pattern or a lower threshold pattern for the measurement pattern of the variable for a given animal.

22. A device as claimed in claim 20, wherein the comparing device compares the measurement pattern of the variable with the stored reference pattern of the variable.

23. A device as claimed in claim 1, wherein the device further comprises a milk line system comprising a plurality of lines and at least one device controlled by the comparison signal for guiding milk flowing through the milk line system to one of the lines.

24. A device as claimed in claim 1, wherein the device comprises a displaying device for displaying the comparison signal.

25. A device as claimed in claim 22, wherein the device comprises a warning device for generating a warning, the warning device responsive to the comparison signal.

26. A device for separating milk obtained from a dairy animal during a milking run, the device comprising:
means for measuring a value of a variable in relation to the dairy animal and for issuing a signal indicative of the measured value; and
processing means for receiving the signal indicative of the measured value and comprising:
memory means for storing a plurality of reference values for the variable corresponding to different periods between milking runs of the dairy animal; and
means for comparing the measured value of the variable with a selected reference value and for issuing a comparison signal,
wherein the selected reference value is selected on the basis of a period since a preceding milking run of the dairy animal and wherein the device further comprises separating means for separating milk in dependence on the comparison signal.

27. A method for separating milk obtained from a dairy animal during a milking run, the method comprising:
measuring a value of a variable in relation to the dairy animal;
storing a plurality of reference values for the variable corresponding to different periods between milking of the dairy animal;
selecting one of the reference values on the basis of a period since a preceding milking run of the dairy animal;
comparing the measured value of the variable with the selected reference value; and
separating the milk based on the result of the comparison.
